(19) United States
(12) Patent Application Publication
(10) Pub. No.: US 2021/0148164 A1
(43) Pub. Date: May 20, 2021

(54) VERTICALLY-SUSPENDED ARCHITECTURAL-STRUCTURE COVERING

(71) Applicant: Hunter Douglas, Inc., Pearl River, NY (US)

(72) Inventors: MICHAEL J. SIEBENALLER, Broomfield, CO (US); KEVIN DANN, Broomfield, CO (US); JOSEPH E. KOVACH, Broomfield, CO (US); KEN WITHERELL, Broomfield, CO (US); DAVID LYNCH, Broomfield, CO (US)

(73) Assignee: Hunter Douglas, Inc., Pearl River, NY (US)

(21) Appl. No.: 17/158,196

(22) Filed: Jan. 26, 2021

Related U.S. Application Data
(63) Continuation of application No. 15/947,975, filed on Apr. 9, 2018.
(60) Provisional application No. 62/621,087, filed on Jan. 24, 2018.
(60) Provisional application No. 62/485,022, filed on Apr. 13, 2017.

(51) Int. Cl. E06B 9/386; E06B 9/36

(52) U.S. Cl. CPC E06B 9/386; E06B 2009/2482; E06B 9/368; E06B 9/36

(57) ABSTRACT

A covering for a vertically-suspended architectural-structure covering is disclosed. The covering is formed from a plurality of assembled vanes suspended from a headrail assembly. Each assembled vane may be made via a strip process. Each vane including a strip of material (e.g., translucent fabric), and at least one slat (e.g., arcuate opaque material) coupled to the strip of material. For example, in one embodiment, the vanes may include first and second slats coupled to an intermediate strip of material on either side of the intermediate strip of material along the vertically extending side portions thereof, respectively. The first and second slats preferably each include a complementary curved surface so that when the assembled vanes are coupled to the headrail assembly, the first slat of a first assembled vane is coupled to or nested with the second slat of a second, adjacent assembled vane.

### CROSS-REFERENCE TO RELATED APPLICATIONS

This application is a continuation application of pending U.S. patent application Ser. No. 15/947,975, filed Apr. 9, 2018, entitled “Vertically-Suspended Architectural-Structure Covering”, which is a non-provisional of, and claims the benefit of the filing date of, pending U.S. provisional patent application No. 62/485,022, filed Apr. 13, 2017, titled “Vertically-Suspended Architectural-Structure Covering,” and is a non-provisional of, and claims the benefit of the filing date of, pending U.S. provisional patent application No. 62/621,087, filed Jan. 24, 2018, titled “Vertically-Suspended Architectural-Structure Covering,” the entirety of which applications are incorporated by reference herein.

### FIELD OF THE DISCLOSURE

The present disclosure relates generally to the field of architectural-structure coverings, and relates more particularly to an improved covering for use in a vertically-suspended architectural-structure covering.

### BACKGROUND

Architectural-structure coverings may selectively cover an architectural structure such as, for example, a window, a doorway, a skylight, a hallway, a portion of a wall, etc. Architectural-structure coverings may come in a variety of configurations. One common type of architectural-structure covering is a vertically-suspended architectural-structure covering. A vertically-suspended architecture-structure covering may include a headrail assembly and a covering. The covering may be manufactured from a plurality of vertically suspended vanes. In use, the plurality of vanes are suspended from the headrail assembly containing a control system. The architectural-structure covering may also include an operating mechanism, for example, a tilt wand and pull cord control system for operatively controlling the angle of the slats and to move the covering between an extended position and a retracted position. As will be readily appreciated by one of ordinary skill in the art, in the extended position, the covering may extend widthwise across the architectural structure (e.g., window), while in the retracted position, the covering may be retracted to reveal the architectural structure. With the vanes vertically oriented, retraction of the covering typically results in closely adjacent stacking of the vertical slats depending at one or both ends of the headrail assembly.

That is, with the covering in the extended position, the operating mechanism (e.g., tilt wand) of the vertically-suspended architecture-structure covering may be used to rotate the plurality of vanes to substantially block view through. In addition, the operating mechanism (e.g., pull cord) may be used to control the amount of extension or retraction of the covering across the architectural structure. By controlling the rotation of the vanes in the extended position and by moving the covering between the extended and retracted positions, the user can control view through the covering and hence, as applied to coverings or windows, the user is able to vary the amount of natural light permitted to enter, for example, the room via the window by adjusting the angular position of the vanes.

The covering may be made from a continuous fabric material that is sized and configured to extend the width and height of the architectural structure (e.g., window). The fabric material may incorporate alternating pieces or layers or strips or sections of opaque, translucent, or transparent material so that rotation of the covering alters the amount of light passing through the covering.

Coverings manufactured from fabric material, especially high-end or delicate fabrics, present several additional challenges that need to be considered. For example, if the fabric has a defect or becomes damaged in any way during manufacturing or installation, the fabric is often discarded in its entirety, resulting in potentially significant monetary cost and waste. In addition, as the covering is manufactured from a single continuous piece of material, the covering prevents anyone from walking or passing through the covering when the covering is in the extended position. Furthermore, due to the relatively large size of the architectural structure and the potentially high cost of the fabric material, many coverings may become too expensive for the average consumer.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is an improved architectural-structure covering. The covering may be used in connection with an architectural-structure covering, for example, a vertically-suspended architectural-structure covering. The covering may be made via a strip process for manufacturing an assembled vane. That is, the covering may be manufactured from a plurality of individual assembled vanes, wherein each assembled vane is made via a strip process. Each assembled vane preferably includes a strip of material, and at least one slat. In one embodiment, each assembled vane may include an intermediate strip of material, and first and second slats on either side of the intermediate strip of material. In an alternate embodiment, each assembled vane may include a strip of material and a single slat coupled to one side of the strip of material. Moreover, in another embodiment, each assembled vane may include a strip of material, and first and second slats wherein the strip of material extends the entire width of the assembled vane, and the first and second slats may be coupled to an inner (e.g., window or wall facing) surface of the strip of material.

In one embodiment, the strip of material is in the form of a translucent or (nearly) transparent material while the slats may be in the form of a semi-opaque or opaque material. The strip of material may be in the form of a translucent, fabric material while the slats may be made from a relatively more opaque material. In addition, or alternatively, the strip of material may be in the form of a translucent, softer, more flexible fabric material while the slats may be formed from a more rigid material (e.g., more rigid as compared to the strip of material) such as a semi-rigid material. In use, in one embodiment, the slats may each include a complementary arcuate or curved surface. When the assembled vanes are coupled to a headrail assembly, the first slat in a first assembled vane may be in close proximity to or in contact with a second slat of an adjacent, second assembled vane. In a further embodiment, the strip of material may be in the form of a flexible fabric material while the slats may be formed from an arcuate or curved semi-rigid opaque material. In use, incorporation of arcuate or curved slats facilitates the nesting of slats in adjacent assembled vanes, thus enhancing the appearance that the nested slats are a single slat and that the covering is a continuous covering.

In this manner, the covering is manufactured from a plurality of individual assembled vanes that provide an end user with the appearance that the covering is manufactured from a continuous fabric covering extending widthwise across the width of the architectural structure (e.g., window).

In addition, a covering according to the present disclosure may be made in an on demand fashion (e.g., lengths of each strip and the number of each strip used in the covering may be readily determined for each covering independently). That is, the strip method of fabrication enables the manufacturer to cut and assemble the vanes in an on-demand fashion utilizing production on-demand type equipment. In addition, the covering facilitates incorporation of fabrics that are not readily available in larger sizes, that may be too soft or too flexible to be used to make larger coverings, or otherwise are too cost prohibitive to be incorporated. For example, by using a strip method of fabrication, smaller, discrete strips of fabric can be joined to more opaque and/or rigid slats (in contrast with a single uniform expanse of material extending the height and width of the covering). In addition, in cases where the fabric material has or incurs a defect, rather than requiring replacement of the entire fabric, the strip method of fabrication enables only the defective strip of material to be replaced, thus minimizing the amount of waste.

### BRIEF DESCRIPTION OF THE DRAWINGS

FIG. 1 is a front perspective view illustrating an example embodiment of an architectural-structure covering assembly including a covering according to the present disclosure shown in an extended position;

FIG. 2 is a partial top view of the architectural-structure covering assembly shown in FIG. 1;

FIG. 3 is a detailed, partial perspective view of the architectural-structure covering assembly shown in FIG. 1;

FIG. 4 is a perspective view illustrating an example embodiment of an assembled vane in accordance with an illustrative embodiment of the present disclosure, the assembled vane lying flat for purposes of illustrating various features and elements thereof;

FIG. 5 is a partial, outer plan view of a top end of the assembled vane shown in FIG. 4;

FIG. 6 is a partial, outer view of the top end of the assembled vane shown in FIG. 4, the assembled vane shown in a folded configuration for purposes of illustrating various features and elements thereof;

FIG. 7 is a partial, exploded cross-sectional view of adjoining assembled vanes;

FIG. 8 is a detailed view of an example embodiment of a coupling mechanism for securing a bottom portion of adjacent, adjoining assembled vanes;

FIG. 9 is a perspective view illustrating an alternate example embodiment of an assembled vane in accordance with an illustrative embodiment of the present disclosure, the assembled vane lying flat for purposes of illustrating various features and elements thereof; and

FIG. 10 is a perspective view illustrating another example embodiment of an assembled vane in accordance with an illustrative embodiment of the present disclosure, the assembled vane lying flat for purposes of illustrating various features and elements thereof.

### DETAILED DESCRIPTION

Embodiments of a covering in accordance with the present disclosure will now be described more fully hereinafter with reference to the accompanying drawings, in which embodiments of the present disclosure are presented. The covering of the present disclosure may, however, be embodied in many different forms and should not be construed as being limited to the embodiments set forth herein. Rather, these embodiments are provided so that this disclosure will convey certain example aspects of the covering to those skilled in the art. In the drawings, like numbers refer to like elements throughout unless otherwise noted.

As will be described in greater detail below, the covering of the present disclosure may be used in connection with an architectural-structure covering, for example, a vertically-suspended architectural-structure covering. Generally speaking, vertically-suspended architectural-structure coverings may be movable between an extended position and a retracted position. In this manner, the covering of the architectural-structure covering may be moved between the extended position, where the architectural structure (e.g., window) is covered, and the retracted position, where the architectural structure is substantially exposed. In addition, for example, when in the extended position, the covering may be tiltable or rotatable so that the angle of the covering may be controlled so that the covering may be more or less opaque.

In accordance with one aspect of the present disclosure, the covering includes a plurality of vertically suspended side-by-side assembled vanes. Each vane being arranged and configured for coupling to a headrail assembly. The covering may be made via a strip process for manufacturing an assembled vane. That is, in accordance with one aspect of the present disclosure, each vane is preferably manufactured from an assembled vane that includes a strip of material and at least one slat. For example, in one embodiment, each vane may be manufactured from an assembled vane that includes an intermediate strip of material, and first and second slats on either side of the intermediate strip of material. In an alternate embodiment, each vane may be manufactured from an assembled vane that includes a strip of material and a slat coupled to one side of the strip of material. Moreover, in another embodiment, each vane may be manufactured from an assembled vane that includes a strip of material, and first and second slats wherein the strip of material extends the entire width of the assembled vane, and the first and second slats may be coupled to an inner (e.g., window or wall facing) surface of the strip of material.

In a strip process of manufacturing, the covering is built up in width by a plurality of vanes arranged in a side by side fashion along a width of the covering (e.g., to create the width of the overall covering). In this manner, the covering is not formed from a unitary sheet of material which extends the full width of the covering. As such, a material having a full width of the covering (and which may need to be narrowed for use in a narrower covering) need not be used. As a result, and as will be described in greater detail herein, the strip process provides numerous advantages including ease of handling, reduction in material waste, etc.

In one embodiment, the strip of material is in the form of a translucent or (nearly) transparent material while the slats may be in the form of a semi-opaque or opaque material. More preferably, the strip of material may be in the form of a translucent, fabric material while the slats may be made from a relatively more rigid material (e.g., more rigid as compared to the strip of material) such as, a semi-rigid material. Moreover, the strip of material may be in the form of a translucent, softer, more flexible fabric material while the slats may be in the form of a semi-rigid opaque material. However, it will be understood that the fabric material may be constructed from other types of material, for example, a plastic material, a vinyl material, etc. Similarly, the slat may be constructed from other types of material, for example, a semi-opaque material, a translucent material, etc.

In one embodiment, the slats may include complementary arcuate or curved surfaces so that when the assembled vanes are arranged into a covering, a first slat of a first assembled vane is in close proximity to or in contact with a second slat of a second, adjacent assembled vane. More preferably, the first slat of the first assembled vane may be nested with the second slat of the second, adjacent assembled vane, thus enhancing the appearance that the nested slats are a single slat and that the covering is a continuous covering. That is, in one embodiment, the strip of material may be in the form of a flexible fabric material while the slats may be formed from an arcuate or curved semi-rigid opaque material to facilitate nesting of slats in adjacent assembled vanes.

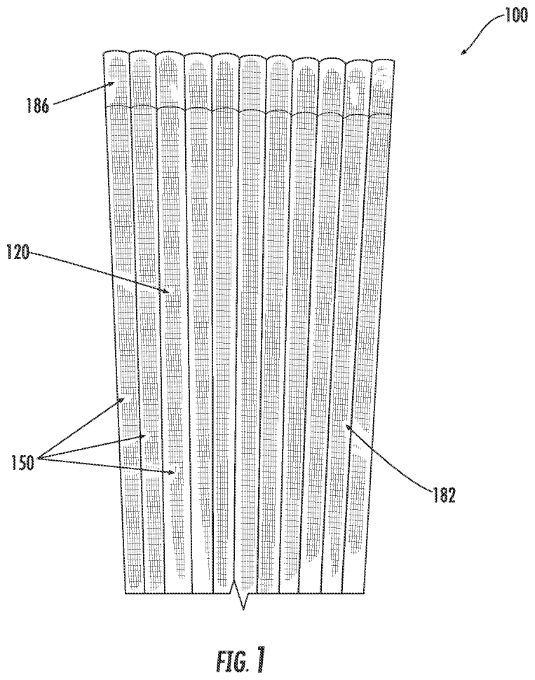

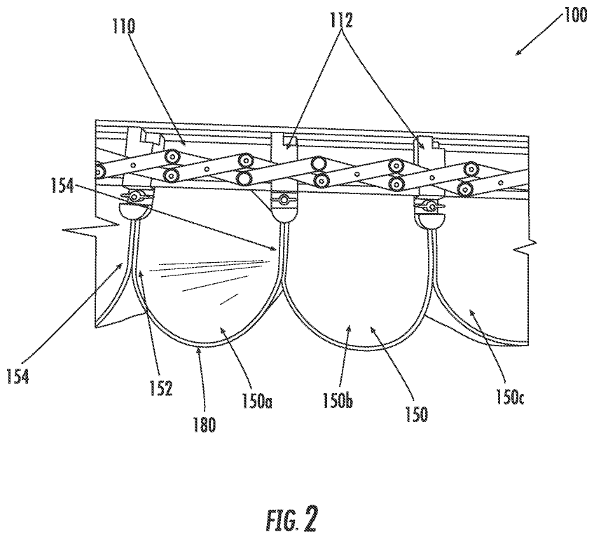

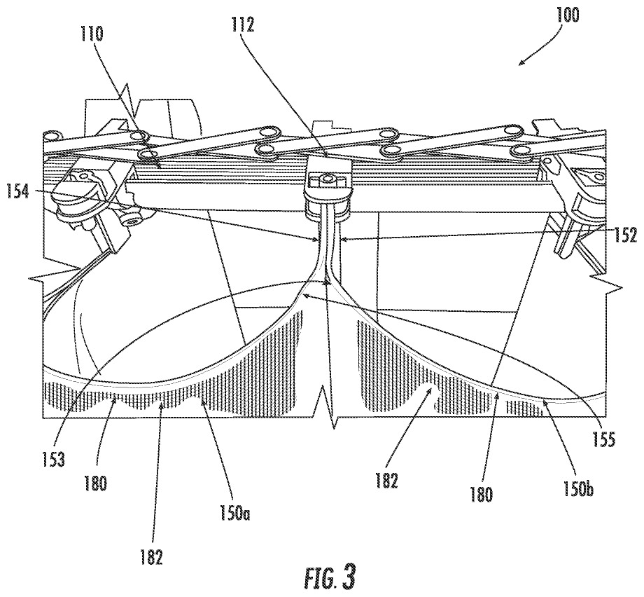

Referring to FIGS. 1 to 3, an example architectural-structure covering 100 is shown. As shown, the architectural-structure covering assembly 100 can include a headrail assembly 110 and a covering 120. The headrail assembly 110 may include, for example, brackets (not shown) for mounting the architectural-structure covering assembly 100 to a wall or other structure. Although a particular example of a headrail assembly 100 is shown in FIGS. 2 and 3, many different types and styles of headrail assemblies exist and could be employed in place of the example headrail assembly of FIGS. 2 and 3. The architectural-structure covering assembly 100 may also include an operating mechanism, for example, a tilt wand and pull cord control system (not shown). In use, the operating mechanism may be used to move the covering 120 between the extended and retracted positions, and to control the angle of the covering 120. The architectural-structure covering 100 may also include a coupling mechanism, for example, a plurality of carriers, clips, hanger pins, etc. 112 for coupling the covering 120 to the headrail assembly 110. As will be readily appreciated by one of ordinary skill in the art, the covering 120 of the architectural-structure covering 100 may be suspended from the headrail assembly 110 and may be movable along the length of the headrail assembly 110 between the extended position (shown in FIG. 1), to a partially retracted position, and to a fully retracted position. In addition, portions of the covering 120 (e.g., assembled vanes) may be rotatable to control the opaque nature of the covering 120, for example, in the extended position.

For the sake of convenience and clarity, terms such as “front,” “rear,” “top,” “bottom,” “up,” “down,” “vertical,” “horizontal”, “inner,” and “outer” may be used herein to describe the relative placement and orientation of various components and portions of the architectural-structure covering 100, and are non-limiting. Said terminology will include the words specifically mentioned, derivatives thereof, and words of similar import.

Referring now to FIGS. 2-6, an assembled vane 150 used for assembling a covering 120 according to an example embodiment of the present disclosure will now be described. In accordance with an illustrative, non-limiting embodiment of the present disclosure, the covering 120 may be manufactured from a plurality of individual vanes, for example, assembled vane 150a, assembled vane 150b, assembled vane 150c, etc. In one embodiment, each assembled vane 150 is made via a strip process for manufacturing an assembled strip of fabric material 150 (hereinafter “assembled vane”). Each assembled vane 150 includes a first slat 152 and a second slat 154 on either side of an intermediate strip of material 180.

In one example embodiment, the intermediate strip of material 180 is in the form of a translucent or (nearly) transparent material while first and second slats 152, 154 on either side of the intermediate strip of material 180 are preferably in the form of a semi-opaque or opaque material. The intermediate strip of material 180 may be in the form of a translucent flexible fabric material while the first and second slats 152, 154 may be in the form of a semi-opaque or opaque material so that light is more readily able to pass through the intermediate strip of material 180 than the first and second slats 152, 154. In addition, or alternatively, the intermediate strip of material 180 may be in the form of a translucent, softer, more flexible fabric material while the first and second slats 152, 154 may be in the form of an arcuate or curved, semi-rigid opaque material. As will be described in greater detail, in use, the assembled vanes 150 and hence the covering 120 will have the appearance of being manufactured from a continuous piece of fabric material. However, it will be understood that the intermediate strip of material 180 may be constructed from any type of material, for example, a plastic material, a vinyl material, etc. Similarly, the first and second slats 152, 154 may be constructed from any type of material, for example, a semi-opaque material, a translucent material, etc.

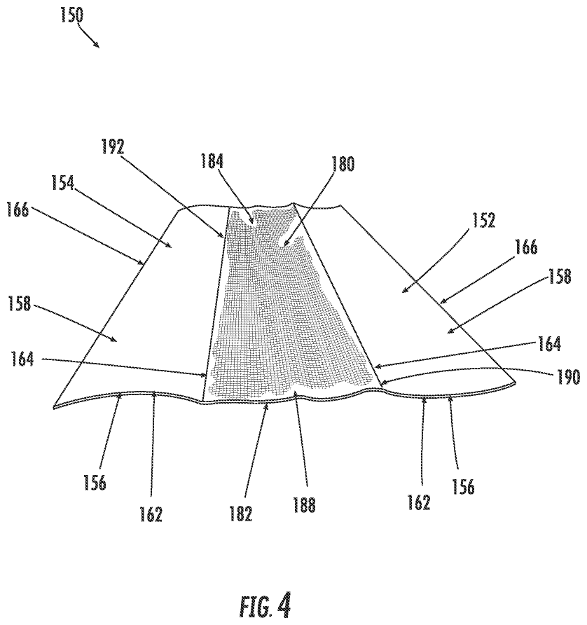

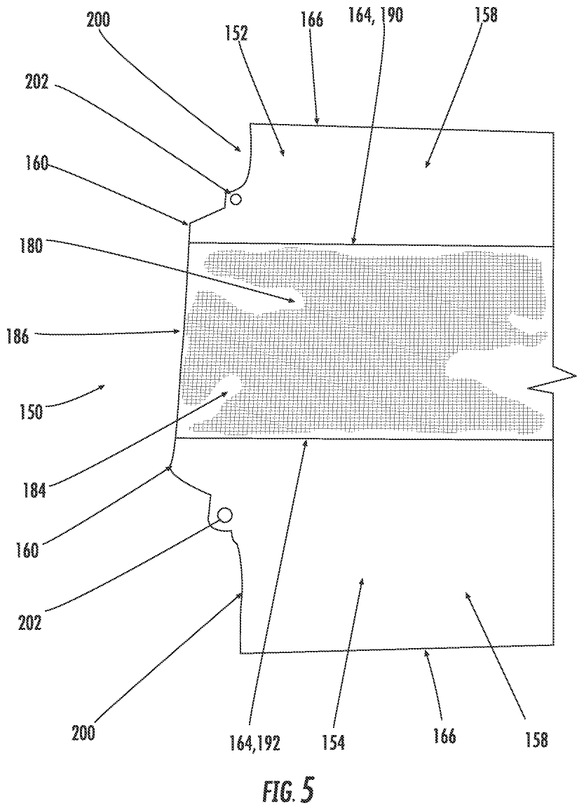

Referring to FIG. 4, the intermediate strip of material 180 may include a first (e.g., room facing) surface 182 (also shown in FIGS. 1 and 3), a second (e.g. window or wall facing) surface 184, a top end 186 (FIG. 5), a bottom end 188, a first side portion 190, and a second side portion 192. Similarly, the first and second slats 152, 154 may each include a first surface 156, a second surface 158, a top end 160 (FIG. 5), a bottom end 162, a first side portion 164 and a second side portion 166. The first side portion 164 of the first slat 152 may be coupled to the intermediate strip of material 180 adjacent the first side portion 190, thereof while the first side portion 164 of the second slat 154 may be coupled to the intermediate strip of material 180 adjacent the second side portion 192, or vice-versa. As such, in one illustrative embodiment, the first and second slats 152, 154 are coupled to either side of the intermediate strip of material 180. The first and second slats 152, 154 may extend lengthwise along the intermediate strip of material 180 from the top end 186 to the bottom end 188 thereof.

The first and second slats 152, 154 may be coupled to the intermediate strip of material 180 by any means including, but not limited to, an adhesive, etc. For example, the adhesive may be specially formulated for sticking to the first and second slats 152, 154. The adhesive may be in the form of a curable glue that appropriately cures with temperature and moisture. Alternatively, the curable glue may appropriately cure through atmospheric conditions and time. In one embodiment, the first and second slats 152, 154 may be attached to the intermediate piece of material 180 as a continuous glue line that extends the length of the slats 152, 154. Alternatively, the first and second slats 152, 154 may be attached to the intermediate piece of material 180 by a non-continuous glue line that includes gaps lacking glue. By incorporating a continuous glue line, the first and second slats 152, 154 may have a stiffer construction whereas a more flexible construction may be achieved by incorporating a skipped glue line.

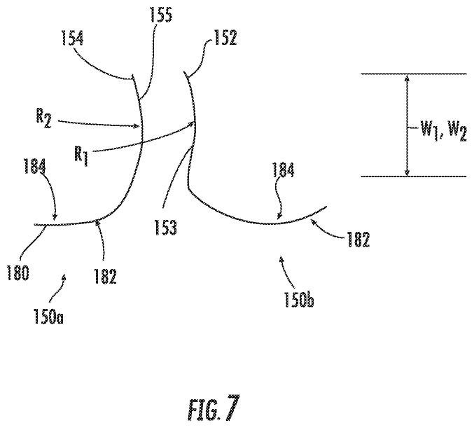

Preferably, as shown in the example embodiment illustrated in FIGS. 3 and 7, the first and second slats 152, 154 include complementary arcuate or curved surfaces so that when the assembled vanes 150 are coupled to and suspended from the headrail assembly 110, the first slat 152 of a first assembled vane 150, for example assembled vane 150b, is nested with a second slat 154 of a second, adjacent assembled vane 150, for example assembled vane 150a. That is, the first slat 152 includes a contact surface 153 (e.g., surface of the first slat 152 that faces the second slat 154 of an adjacent, second assembled vane 150). Similarly, the second slat 154 includes a contact surface 155 (e.g., surface of the second slat 154 that faces the first slat 152 of an adjacent, second assembled vane 150). The contact surface 153 of the first slat 152 may have a concave, arcuate shape while the contact surface 155 of the second slat 154 may have a convex, arcuate shape (or vice-versa) so that when the assembled vanes 150 are coupled to the headrail 110, the contact surface 153 of the first slat 152 in a first assembled vane 150 is in contact with the contact surface 155 of the second slat 154 of a second, adjacent assembled vane 150, and the second slat is nested within the first slat 152. That is, the contact surface 153 of the first slat 152 preferably has a concave, arcuate shape while the contact surface 155 of the second slat 154 has a convex, arcuate shape, or vice-versa so that when the assembled vanes 150 are coupled to the headrail 110, the contact surfaces 153, 155 of the first and second slats 152, 154 are adjacent assembled vanes 150 nest and correspond with one another so that they may appear to be a single slat with the same curvature. It will be appreciated that the first and second slats 152, 154 may have other shapes, for example, the first and second slats 152, 154 may be flat or substantially flat. In this manner, the first and second slats 152, 154 may not contact or nest with one another but rather may slide with respect to one another more so than slats 152, 154 having an arcuate or curved shape.

The contact surfaces 153, 155 of the first and second slats 152, 154 may be substantially devoid of any overlapping fabric material 180 thus minimizing any material 180 between the contact surfaces 153, 155. As such, when the first slat 152 of a first assembled vane 150 is nested with the second slat 154 in a second, adjacent assembled vane 150, the first and second contact surfaces 153, 155 of the first and second slats 152, 154, respectively, may be substantially free of any fabric material so that, when in the nested configuration, there is little to no fabric material between the first and second contact surfaces 153, 155.

In one embodiment, the first side portion 164 of the first slat 152 and the first side portion 164 of the second slat 154 may be partially wrapped or covered by the intermediate strip of material 180. In this manner, when the covering 120 is in the closed position, the overlapping fabric helps contribute to the appearance that the covering 120 is manufactured from one continuous piece of fabric. That is, by partially overlapping the edge of the slats 152, 154 with the intermediate strip of material 180 (e.g., fabric), the edge of slats 152, 154 is concealed by the intermediate strip of material 180 thus providing the covering 120 with a more aesthetic finish that appears to be made entirely by the intermediate strip of material 180 (e.g., fabric).

In one example embodiment, the first and second slats 152, 154 may have the same size (e.g., width and length), although it is envisioned that the first and second slats 152, 154 may be provided in first and second sizes, respectively. For example, in one embodiment, the first and second slats 152, 154 may have a width of approximately 3½″ while the intermediate strip of material 180 may have a width of approximately 4½″. Preferably, the widths of the first and second slats 152, 154 are in direct relationship to the spacing of the carriers 112 of the track located in the headrail assembly 110 from which the slats 152, 154 hang. In this manner, the carrier spacing of the track allows for the slats 152, 154 to overlap each other when closed (e.g., when slats 152, 154 are closed but the architectural structure covering is in an extended position) to create privacy. One of ordinary skill in the art will appreciate that these dimensions are examples and that other dimensions may be used. For example, one slat may have a smaller width than the other slat. In one embodiment, for example, it is envisioned that one slat may have a smaller width than the other slat, in such embodiment, it is envisioned that the smaller width slat of a first assembled vane may be coupled to the larger width slat of a second, adjacent assembled vane, for example, adjacent to the room facing surface of the covering 120.

The first and second slats 152, 154 preferably include equal, but opposite, radii of curvature to facilitate nesting of the first and second slats 152, 154. That is, the first slat 152 may have a radius of curvature R₁ and second slat 154 may have a radius of curvature R₂. R₁ may be substantially equal to or equal to R₂. In this manner, the internal radius (e.g., radius of curvature of the contact surface 153) of the first slat 152 and the external radius (e.g., radius of curvature of the contact surface 155) of the second slat 154, or vice-versa, are preferably equal so that a maximum contact surface between the first and second slats 152, 154 is achieved so that, when joined, the first slat 152 of a first assembled vane 150 may be nested with the second slat 154 of a second assembled vane 150. Incorporating substantially similar radii of curvatures help facilitate the nested first and second slats 152, 154 having the appearance of being a single slat. Preferably, the first and second slats 152, 154 include sufficient radii of curvature so that light cannot pass through the nested contact surfaces 153, 155 of the first and second slats 152, 154, respectively. However, preferably, the radii of curvature of the first and second slats 152, 154 are not so large as to prevent walk-through or pass-through, if desired, as will be described in greater detail below. In one non-limiting example embodiment, the radius of curvature may be approximately 3″. Alternatively, it is envisioned that the first and second slats 152, 154 may have different radii of curvature. One of ordinary skill in the art will appreciate that these dimensions are examples and that other dimensions may be used.

As previously mentioned, the first and second slats 152, 154 may be coupled to the intermediate strip of material 180 by any means including, but not limited to, an adhesive. In one example embodiment, the first and second slats 152, 154 partially overlap with the intermediate strip of material by approximately ⅛″ so as maximize the size of the contact surfaces 153, 155. One of ordinary skill in the art will appreciate that all of the aforementioned dimensions are merely examples and non-limiting and that other dimensions may be used while still remaining within the scope of the disclosure.

The slats 152, 154 may be manufactured from any appropriate material known in the art including, but not limited to, a polycarbonate or nonwoven material, a moldable polyethylene terephthalate (PETG) film, a plastic material, a metal material (such as, for example, aluminum), etc. Preferably, the slats 152, 154 are manufactured from a film type material sandwiched between two layers of a moldable non-woven material. The film material could be either a clear or opaque film depending on needs. In one example embodiment, the slats 152, 154 may include first and second layers. For example, in a preferred embodiment, the slats 152, 154 may include a non-woven layer and a rigid layer such as, for example, a polyethylene (or other polymer) layer. The layers may be bonded together. As such, the slats 152, 154 may be coupled to either side of the intermediate strip of material 180 by sandwiching a portion of the first side portion 190 of the intermediate strip of material 180 between the layers of the first slat 152, and a portion of the second side portion 192 of the intermediate strip of material 180 between the layers of the second slat 154.

Referring to FIGS. 2, 3 and 7, when the first slat 152 of a first assembled vane, for example, assembled vane 150b, is nested with or in contact with the second slat 154 of a second, adjacent assembled vane, for example, assembled vane 150a, the first and second slats 152, 154 may be in contact with each other along the entire length of the contact surfaces 153, 155, and hence appear as a single slat. In one embodiment, when nested, the top end 160 of the second slat 154 of a first assembled vane 150 is substantially aligned with the top end 160 of the first slat 152 of a second assembled vane 150, the bottom end 162 of the second slat 154 of a first assembled vane 150 is substantially aligned with the bottom end 162 of the first slat 152 of a second assembled vane 150, and the second side portion 166 of the second slat 154 of a first assembled vane 150 is aligned with the second side portion 166 of the first slat 152 of a second assembled vane 150.

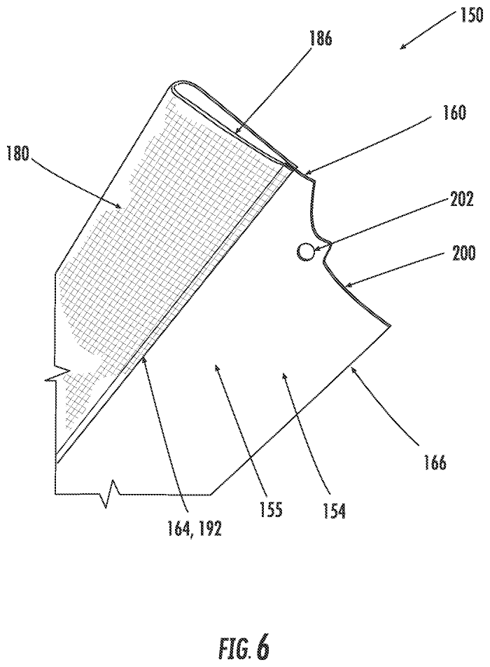

Referring to the example embodiment illustrated in FIGS. 5 and 6, the top ends 160 of each of the first and second slats 152, 154, respectively, include a notched area 200 having an opening 202 for facilitating coupling, such as, via a carrier, clip, hanger pin, or other mechanism 112 known to couple a covering to a headrail assembly 110 as illustrated in FIGS. 2 and 3. That is, the top end 160 of the first and second slats 152, 154 each include an opening 202 formed therein, the opening 202 of the first slat 152 of a first assembled vane 150 being substantially aligned with the opening 202 of the second slat 154 of a second assembled vane 150, when the assembled vanes 150 are in the nested configuration, for coupling the adjacent assembled vanes 150 to the headrail assembly 110. In one embodiment, the opening 202 may be formed or punched directly into the first and second slats 152, 154. Alternatively, a reinforcing tab may be fitted to the first and second slats 152, 154, the reinforcing tab including the opening for coupling the assembled vanes 150 to the headrail assembly 110.

Referring to FIG. 1, the top end 186 of the intermediate strip of fabric 180 may include additional fabric material, a thicker weave of material, or the like similar to that used in connection with the top valance of the headrail assembly 110 to conceal the headrail assembly 110.

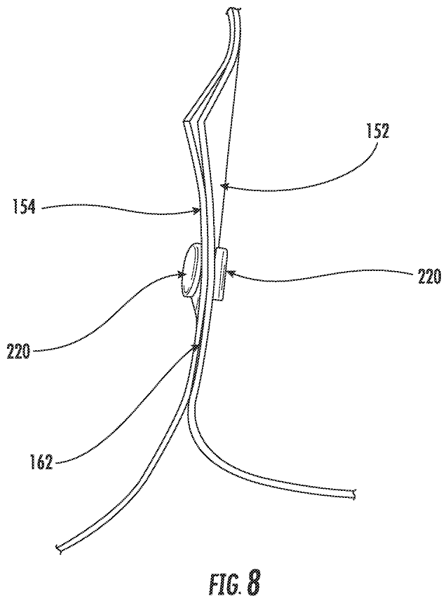

In one embodiment, adjacent assembled vanes 150 are free from any connection with respect to one another other than via their coupling to the headrail assembly 110. That is, the first and second slats 152, 154 in adjacent assembled vanes 150 are coupled to one another solely at the top ends 160 thereof via the coupling to the headrail assembly 110 for example, via the carriers 112 engaging the openings 202. In this manner, adjacent assembled vanes 150 are movable with respect to one another and thus permit a user to pass or walk through the covering 120 in the extended position. By providing nested first and second slats 152, 154, adjacent assembled vanes 150 come back or fall back together after a user passes through. This embodiment is particularly beneficial, for example, when the architectural-structure covering 100 is being mounted in front of a door, a sliding door, a hallway, etc. Alternatively, referring to FIG. 8, the first and second slats 152, 154 may include a coupling mechanism 220, other than the coupling mechanism (e.g., openings 202) for coupling the assembled vanes 150 to the headrail assembly 110. This second coupling mechanism 220 may be disposed at one or more locations along the length of the first and second slats 152, 154 and may be used for coupling the first slat 152 in a first assembled vane 150 to the second slat 154 in a second, adjacent assembled vane 150. The coupling mechanism 220 may be any known or hereafter developed mechanism for coupling the first slat 152 to the second slat 154 including, but not limited to, snaps, hook and loop material (Velcro®), magnets, etc. For example, as shown in FIG. 8, the first and second slats 152, 154 may include a coupling mechanism 220 attached to the first and second slats 152, 154 at the bottom end 162 thereof, while the top ends 160 of the first and second slats 152, 154 may be coupled to one another, and to the headrail assembly 110. Preferably, in use, the coupling mechanism 220 is coupled to the first and second slats 152, 154 so that the coupling mechanism 220 is prevented from being dislodged from the first and second slats 152, 154. Alternatively, the first and second slats 152, 154 may be coupled to one another, for example, along the second side portions 166 thereof. The coupling mechanism could also be positioned between the top ends 160 and bottom ends 162. Preferably, the coupling mechanism would include a self-guiding feature to facilitate coupling thereof.

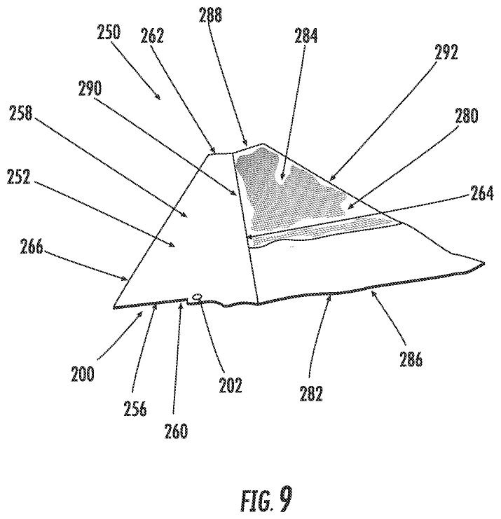

Referring to FIG. 9, an alternate example embodiment of an assembled vane 250 used for assembling a covering 120 according to an example embodiment of the present disclosure will now be described. The assembled vane 250 is substantially similar to the assembled vane 150 previously described above but for differences described herein. As previously described, in accordance with an illustrative, non-limiting embodiment of the present disclosure, the covering 120 may be manufactured from a plurality of individual vanes 250. In one embodiment, each vane 250 is made via a strip process for manufacturing an assembled strip of fabric material 250 (hereinafter “assembled vane”). In accordance with the example embodiment of FIG. 9, each assembled vane 250 includes a slat 252 coupled to one side of a strip of material 280.

The strip of material 280 may include a first (e.g., room facing) surface 282, a second (e.g., window or wall facing) surface 284, a top end 286, a bottom end 288, a first side portion 290, and a second side portion 292. Similarly, the slat 252 may include a first surface 256, a second surface 258, a top end 260, a bottom end 262, a first side portion 264, and a second side portion 266. The first side portion 264 of the slat 252 may be coupled to the strip of material 280 adjacent the first side portion 290 thereof. Alternatively, the first side portion 264 of the slat 252 may be coupled to the strip of material 280 adjacent the second side portion 292 thereof. As such, in one illustrative embodiment, the slat 252 is coupled to one side of the strip of material 280. The slat 252 may extend lengthwise along the strip of material 280 from the top end 286 to the bottom end 288 thereof.

As shown in the example embodiment illustrated in FIG. 9, the slat 252 may include an arcuate or curved surface so that when adjacent assembled vanes 250 are coupled to and suspended from the headrail assembly 110, the arcuate or curved contact surface of the slat 252 of a first assembled vane 250 may contact and partially nest with the strip of material 280 of a second, adjacent assembled vane 250. That is, as previously described, the slat 252 includes a contact surface (e.g., surface of the slat 252 that faces the strip of material 280 of an adjacent, second assembled vane 250). The contact surface of the slat 252 may have a curved, arcuate shape so that when the assembled vanes 250 are coupled to the headrail 110, the contact surface of the slat 252 in a first assembled vane 250 may contact the strip of material 280 of a second, adjacent assembled vane 250. When assembled (e.g., when the assembled vanes 250 are coupled to the headrail 110), the strip of material 280 may conform to the arcuate, curved surface of the contact surface of the slat 252 on the adjacent assembled vane 250, so that the covering 120 appears to be manufactured from one continuous piece of fabric. It will be appreciated that the slat 252 may have other shapes, for example, the slat 252 may be flat or substantially flat. In this manner, adjacent contacting surfaces may not contact or nest with one another but rather may slide with respect to one another more so than slats having an arcuate or curved shape.

As previously mentioned, the contact surface of the slat 252 may be substantially devoid of any overlapping fabric material 280 thus minimizing any material 280 between the contact surface of the slat 252 and the strip of material 280 of an adjacent assembled vane 250. As such, when the slat 252 of a first assembled vane 250 contacts the strip of material 280 of a second, adjacent assembled vane 250, the contact surfaces of the adjacent, assembled vanes 250 may be substantially free of any fabric material so that there is little to no fabric material between the contact surfaces.

In one embodiment, the first side portion 264 of the slat 252 may be partially wrapped, covered or overlapped by the strip of material 280. In this manner, when the covering 120 is in the closed position, the overlapping fabric helps contribute to the appearance that the covering 120 is manufactured from one continuous piece of fabric. That is, by partially overlapping the edge of the slat 252 with the strip of material 280 (e.g., fabric), the edge of the slat 252 is concealed by the strip of material 280 thus providing the covering 120 with a more aesthetic finish that appears to be made entirely by the strip of material 280 (e.g., fabric). In one example embodiment, the slat 252 partially overlaps with the strip of material 280 by approximately ¼″. One of ordinary skill in the art will appreciate that the aforementioned dimension is merely an example and non-limiting and that other dimensions may be used while still remaining within the scope of the disclosure.

In one example embodiment, the strip of material 280 may have a width that is greater than the width of the slat 252. For example, the strip of material 280 and the slat 252 may have a width ratio of 60:40, although it is envisioned that other ratios may be used. For example, in one non-limiting example embodiment, the strip of material 280 may have a width of approximately 5¼″ while the slat 252 may have a width of approximately 3½″. Preferably, the width of the slat 252 is in direct relationship to the spacing of the carriers 112 of the track located in the headrail assembly 110 from which the slat 252 hangs. In this manner, the carrier spacing of the track allows for the slats 252 to overlap one another when closed (e.g., when slats 252 are closed but the architectural structure covering is in an extended position) to provide privacy. One of ordinary skill in the art will appreciate that all of the previously-described dimensions are examples and that other dimensions may be used.

In one embodiment, the slat 252 may be manufactured from a non-woven fabric having a width of approximately 7″. In use, the non-woven fabric may be folded in half to achieve a 3½″ width dimension. In this manner, the slat 252 provides a spine or structural member to the assembled vane and ultimately, the window covering assembly. In use, the greater the cell opening, the stronger/stiffer the spine. In use, the folded slat 252 may be ultrasonically welded closed at the top end 260 thereof. For example, the top ends 260 of the folded slat 252 may be ultrasonically welded to each other (e.g., the first surface 256 of the slat 252 may be ultrasonically welded to the second surface 258 of the slat 252). Next, or at that same time, a hole may be punched (e.g., ultrasonically) through the assembled vane 250 (e.g., slat 252), allowing the assembled vane 250 to be hung from the headrail. In addition, it is envisioned, that since the embodiment of the assembled vane 250 utilizes a single attachment point to the headrail, the assembled vane 250 may take on a number of other forms, for example, a flat wood slat, a PVC vane with a single curve or an S-curve, or other material/configuration.

As previously mentioned, the slat 252 may be coupled to the strip of material 280 by any means including, but not limited to, an adhesive, heat bonding, ultrasonic welding, and the like. The slat 252 may be manufactured from any appropriate material. For example, in one embodiment, the slat 252 may be manufactured from a polyester, non-woven fabric. Alternatively, the slat 252 may be manufactured as a multi-layer slat, as previously described.

In one embodiment, when the slat 252 of a first assembled vane 250 is in contact with the strip of material 280 of a second, adjacent assembled vane 250, the strip of material 280 overlaps the contacting slat 252 by approximately 1″. In this manner, the adjacent contacting assembled vanes appear as one continuous piece of fabric. One of ordinary skill in the art will appreciate that the aforementioned dimension is merely an example and non-limiting and that other dimensions may be used while still remaining within the scope of the disclosure.

When the slat 252 of a first assembled vane 250 is in contact with the strip of material 280 of a second, adjacent assembled vane 250, the slat 252 and the strip of material 280 may be in contact with one another along the entire length, and hence appear as one continuous piece of fabric. In one embodiment, the top end 260 of the slat 252 of a first assembled vane 250 is substantially aligned with the top end 286 of the strip of material 280 of a second assembled vane 150, the bottom end 262 of the slat 252 of a first assembled vane 250 is substantially aligned with the bottom end 288 of the strip of material 280 of a second assembled vane 250, and the second side portion 266 of the slat 252 of a first assembled vane 250 is aligned with the second side portion 292 of the strip of material 280 of a second assembled vane 250.

As shown and as previously mentioned, the top end 260 of each slat 252 may include a notched area 200 having an opening 202 for facilitating coupling, such as, via a carrier, clip, hanger pin, or other mechanism 112 known to couple a covering to a headrail assembly 110 as illustrated in FIGS. 2 and 3.

In connection with the embodiment illustrated in FIG. 9, adjacent assembled vanes 250 may include a coupling mechanism (not shown), other than the coupling mechanism (e.g., openings 202) for coupling the assembled vanes 250 to the headrail assembly 110. This second coupling mechanism may be disposed at one or more locations along the length of the adjacent assembled vanes 250 and may be used for coupling the slat 252 in a first assembled vane 250 to the strip of material 280 in a second, adjacent assembled vane 250. The coupling mechanism may be any known or hereafter developed mechanism for coupling the slat 252 to the strip of material 280 including, but not limited to, snaps, hook and loop material (Velcro®), magnets, etc. For example, the slat 252 in a first assembled vane 250 and the strip of material 280 in a second, adjacent assembled vane 250 may include a coupling mechanism at a top end thereof. In addition, and/or alternatively, the slat 252 in a first assembled vane 250 and the strip of material 280 in a second, adjacent assembled vane 250 may include another coupling mechanism at a bottom end thereof. Meanwhile, the top end of the slats 252 may be coupled to the headrail assembly 110. In addition, the slat 252 in a first assembled vane 250 and the strip of material 280 in a second, adjacent assembled vane 250 may be coupled to one another along the length thereof, at a single point, multiple points, or continuous along the length.

As shown and as previously mentioned, the top end 286 of the strip of fabric 280 may include additional fabric material, a thicker weave of material, or the like similar to that used in connection with the top valance of the headrail assembly 110 to conceal the headrail assembly 110.

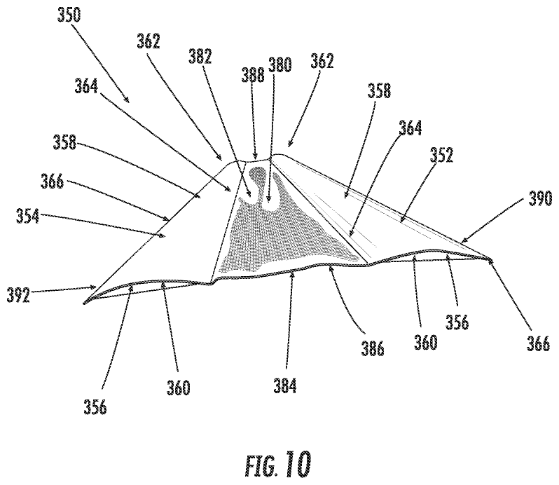

Referring to FIG. 10, an alternate example embodiment of an assembled vane 350 used for assembling a covering 120 according to an example embodiment of the present disclosure will now be described. The assembled vane 350 is substantially similar to the assembled vane 150 previously described above but for differences described herein. As previously described, in accordance with an illustrative, non-limiting embodiment of the present disclosure, the covering 120 may be manufactured from a plurality of individual vanes 350. In one embodiment, each vane 350 is made via a strip process for manufacturing an assembled strip of fabric material 350 (hereinafter “assembled vane”). In accordance with the example embodiment of FIG. 10, each assembled vane 350 includes first and second slats 352, 354 coupled to a strip of material 380.

The strip of material 380 may include an inner (e.g., window or wall facing) surface 382, an outer (e.g., room facing) surface 384, a top end 386, a bottom end 388, a first side portion 390, and a second side portion 392. In the example embodiment of FIG. 10, the strip of material 380 may extend the entire width of the assembled vane 350. That is, the strip of material 380 may extend from the first side portion 390 to the second side portion 392. The first and second slats 352, 354 may each include a first surface 356, a second surface 358, a top end 360, a bottom end 362, a first side portion 364, and a second side portion 366. In the example embodiment of FIG. 10, the first and second slats 352, 354 may be coupled to the inner (e.g., window or wall facing) surface 382 of the strip of material 380. In one example embodiment, the first and second slats 352, 354 are coupled to the inner (e.g., window or wall facing facing) surface 382 of the strip of material 380 along the first and second side portions 364, 366 of the slats 352, 354. For reasons that will be discussed in greater detail, the first and second slats 352, 354 are preferably coupled to the strip of material 380 so that the first and seconds slats 352, 354 are biased to have a substantially bowed or curved, arcuate surface.

By this arrangement, when the assembled vanes 350 are hanging from the headrail assembly 110, the first and second slats 352, 354 of each assembled vane 350 will be located on the inner (e.g., window or wall facing) surface 382 of each assembled vane 350 facing one another, while the outer (e.g., room facing) surface 384 of each assembled vane 350 will be manufactured from a continuous piece of strip of material 380. As such, the appearance of the first and second slats 352, 354 of each assembled vane 350 may be hidden from the homeowner. Alternatively, the first and second slats 352, 354 may be coupled to the outer (e.g., room facing) surface 384 of the strip of material 380 along the first surface 356 of the first and second slats 352, 354.

The first and second slats 352, 354 may extend lengthwise along the strip of material 380 from the top end 386 to the bottom end 388 thereof. When assembled, the second side portion 366 of the first slat 352 may be substantially aligned with the first side portion 390 of the strip of material 380 while the second side portion 366 of the second slat 354 may be substantially aligned with the first side portion 392 of the strip of material 380. Alternatively, in one embodiment, the first side portion 390 of the strip of material 380 may partially wrap or cover the second side portion 366 of the first slat 352 and the first side portion 392 of the strip of material 380 may partially wrap or cover the second side portion 366 of the second slat 354.

As previously mentioned, in the example embodiment illustrated in FIG. 10, the first and second slats 352, 354 may include a bowed or curved, arcuate surface. Incorporation of an arcuate or curved surface in each of the first and second slats 352, 354 provides increased structural stability sufficient to maintain the non-structural strip of material 380 (e.g., aesthetic fabric) in a desired configuration and/or form. As such, when the assembled vanes 350 are coupled to and suspended from the headrail assembly 110, an aesthetically appealing covering is provided. It will be appreciated that the first and second slats 352, 354 may have other shapes, for example, the first and second slats 352, 354 may be configured to be flat or substantially flat.

As previously mentioned, in one example embodiment, the first and second slats 352, 354 may have the same size (e.g., width and length), although it is envisioned that the first and second slats 352, 354 may be provided in first and second sizes, respectively. For example, in one embodiment, the first and second slats 352, 354 may have a width of approximately 3½″ while the strip of material 380 may have a width of approximately 11½″.

As previously mentioned, the first and second slats 352, 354 may be coupled to the strip of material 380 by any means including, but not limited to, an adhesive, heat bonding, ultrasonic welding and the like.

When the contact surface (e.g., portion of the strip of material 380 overlapping a first slat 352) of a first assembled vane 350 is in contact with the contact surface (e.g., portion of the strip of material 380 overlapping a second slat 354) of a second, adjacent assembled vane 350, the contact surfaces may be in contact with one another along the entire length thereof, and hence appear as one continuous piece of fabric.

As previously mentioned, the top end 360 of each slat 352, 354 may include a notched area having an opening for facilitating coupling to a headrail assembly 110 as illustrated in FIGS. 2 and 3.

As previously mentioned, the top end 386 of the strip of fabric 380 may include additional fabric material, a thicker weave of material, or the like similar to that used in connection with the top valance of the headrail assembly 110 to conceal the headrail assembly 110.

In one embodiment, as previously mentioned, adjacent assembled vanes 350 are free from any connection with respect to one another other than via their coupling to the headrail assembly 110. That is, for example, adjacent assembled vanes 350 are coupled to one another solely at the top ends thereof via the coupling to the headrail assembly 110. In this manner, adjacent assembled vanes 350 are movable with respect to one another and thus permit a user to pass or walk through the covering 120 in the extended position. Alternatively, the adjacent assembled vanes 350 may include a coupling mechanism (a second coupling mechanism), other than the coupling mechanism (e.g., openings) for coupling the assembled vanes 350 to the headrail assembly 110. The coupling mechanism may be any known or hereafter developed mechanism for coupling the adjacent assembled vanes 350 including, but not limited to, snaps, hooks and loops material (Velcro®), magnets, etc.

As previously mentioned, by positioning or nesting the contact surfaces of adjacent assembled vanes 150, 250, 350, for example, the first slat 152 in a first assembled vane 150 with the second slat 154 in a second, adjacent assembled vane 150, contact surfaces (e.g., first and second slats 152, 154 in adjacent assembled vanes 150) have the appearance of a single vane manufactured from a single piece of material. Moreover, the curved shape of the strip of fabrics 180, 280, 380 in combination with the spacing of the assembled vanes 150, 250, 350 results in the strips of fabrics 180, 280, 380 naturally contacting one another, and thus substantially preventing light from passing between adjacent assembled vanes 150, 250, 350. In this manner, manufacturing a covering 120 from a plurality of individual assembled vanes 150, 250, 350, creates the appearance that the entire covering 120 is manufactured from a continuous piece of fabric that extends across the entire width of the, for example, window. As such, the covering 120 has the appearance of being manufactured from a continuous piece of fabric material, similar to existing continuous coverings, even though the improved covering is manufactured from a plurality of individual vanes.

Furthermore, manufacturing a covering 120 from a plurality of assembled vanes 150, 250, 350, as disclosed herein provides numerous advantages. For example, manufacturing a covering 120 via assembled vanes 150, 250, 350, facilitates construction via an automated, production-on-demand methodology. That is, because the assembled vanes 150, 250, 350, can be manufactured in a uniform manner and size, assembled vanes 150, 250, 350, can be mass-produced in a uniform, repeatable process and then assembled together as needed to meet the requirements and/or sizes of the particular application. For example, machinery can be setup to receive fabric material and slats from large rolls of material, respectively, to cut the material into specified heights (and optionally also cut to a desired width) and to affix the slats to the material covering in an automated fashion.

Manufacturing a covering 120 via assembled vanes 150, 250, 350, also minimizes material waste. Utilizing the assembled vanes 150, 250, 350, allows one to receive a strip of material 180, 280, 380, cut it to the desired height and, if necessary, desired width with very minimal waste. Alternatively, the strip of material 180, 280, 380 may be provided in the desired width. That is, by using a strip method of fabrication, rolls of material 180, 280, 380 can be provided in the desired width, or optionally, cut to the desired width. Similarly, rolls of material for the slats 152, 154, 252, 352, 354 can be provided in the desired width, or optionally, cut to the desired width. Thereafter, the rolls of material can be rotated so that the material may be pulled from the roll and cut to any desired length, which is sized to extend the height of the covering 120. More specifically, the fabric material 180, 280, 380 can be pulled to its desired length from its roll. Thereafter, for example, an adhesive can be applied along the side portions of the fabric material 180, 280, 380. Next, the slat material can be pulled from its roll and cut to its desired length. The slats 152, 154, 252, 352, 354 can then be bonded to the fabric material 180, 280, 380. In one embodiment, the slats 152, 154, 252, 352, 354 can be cut to the desired width. Next, the slats 152, 154, 252, 352, 354 may be passed through a forming machine that sets the desired curved shape. As the curved slats 152, 154, 252, 352, 354 are coming out of the forming area of the machine, the strip of material 180, 280, 380, which has also been cut to the desired width, is then adhered to the curved slats 152, 154, 252, 352, 354. The assembled vane 150, 250, 350 is then cut to length. It will be appreciated that other manners of coupling separate materials (other than adhesive bonding) are within the scope of the present disclosure.

In addition, manufacturing a covering 120 via assembled vanes 150, 250, 350 according to the present disclosure facilitates use of narrower rolls of materials (e.g., strip of material, slats, etc.) as the covering 120 is manufactured via coupling adjacent assembles vanes in contrast to a single continuous piece of fabric. As a result, the material is easier to store, handle, and load during manufacturing since, for example, the rolls of material need only correspond to the width of the material as opposed to the width of the covering.

Moreover, generally speaking, if purchased material has a stain or tear, under conventional methodology, the entire piece of material must be discarded. However, in accordance with the present disclosure, since the covering is manufactured from discrete strips of fabric coupled together (in contrast with a single uniform expanse of material extending the height and width of the covering 120), only the defective strip of material needs to be discarded, thus minimizing the total amount of associated waste.

In addition, by using a strip method of fabrication, material that is normally not readily available in larger sizes, or that may be too soft, too flexible, or too stiff to be used to make larger coverings can be utilized. Generally speaking, delicate materials may only be available in certain sizes. Thus, use of delicate materials in covering manufacturing is generally limited. By utilizing the assembled vanes 150, 250, 350 in accordance with the present disclosure however, delicate fabrics can be used to manufacture larger coverings since the fabric material is only needed to manufacture the strip of material 180, 280, 380. The length of the covering may then be customizable by increasing or decreasing the number of assembled vanes 150, 250, 350 joined together. That is, by using a strip method of fabrication, material that is normally not readily available in larger widths (e.g., widths greater than about 54″) can be utilized by rotating the material so that the fabric material may be cut from a roll of material to any desired length, which is sized to extend the height of the covering. The width of the covering may then be customizable by increasing or decreasing the number of assembled vanes joined together, or by varying the width of each assembled vane. In this manner, limitations associated with using delicate materials in covering manufacturing are eliminated or minimized.

In addition, by coupling the fabric strip 180, 280, 380 to adjacent semi-rigid slats 152, 154, 252, 352, 354, the assembled vanes 150, 250, 350 have increased rigidity thus enabling the use of materials that would otherwise be too soft or too flexible to be used if they were required to hang from the headrail assembly 110 by themselves. The slats 152, 154, 252, 352, 354 provide increased structure or rigidity to the assembled vanes 150, 250, 350.

This method also lends itself to producing many varieties of covering from view-through to room-darkening and insulating properties similarly by modifying the material or adding another piece of material. For example, by adding a strip of room-darkening material within the nested vanes, the covering 120 can be easily converted into a room-darkening covering that minimizes or eliminates substantially all light from passing therethrough. It also allows for easily combining of assembled vanes 150, 250, 350 having a room darkening characteristic, with other assembled vanes 150, 250, 350 having a translucent characteristic, in the same window covering. This feature can also be used to combine fabrics of different types (e.g. a heavy drapery type fabric and a light sheer type fabric) within the same window covering.

In accordance with the present disclosure, in one embodiment, a vertically-suspended architectural-structure covering is disclosed. The architectural-structure covering comprises a headrail assembly and a plurality of vertically suspended side-by-side assembled vanes suspended from the headrail assembly, each assembled vane being coupled to the headrail assembly. Each assembled vane includes a fabric material, a first slat, and a second slat. The fabric material includes an inner surface, an outer surface, a top end, a bottom end, a first side portion, and a second side portion. The first slat includes a first surface, a second surface, a top end, a bottom end, a first side portion, and a second side portion. The first side portion of the first slat is coupled to the first side portion of the fabric material. The first slat has a first contact surface configured to contact a second contact surface of an adjacent assembled vane. The second slat includes a first surface, a second surface, a top end, a bottom end, a first side portion, and a second side portion. The first side portion of the second slat is coupled to the second side portion of the fabric material. The second slat has a second contact surface configured to contact a first contact surface of an adjacent assembled vane.

In an alternate embodiment, the architectural-structure covering comprises a headrail assembly and a plurality of vertically suspended side-by-side assembled vanes suspended from the headrail assembly, each assembled vane being coupled to the headrail assembly. Each assembled vane includes a fabric material and a slat. The fabric material includes an inner surface, an outer surface, a top end, a bottom end, a first side portion, and a second side portion. The fabric material including a second contact surface. The slat including a first surface, a second surface, a top end, a bottom end, a first side portion, and a second side portion. The first side portion of the slat is coupled to the first side portion of the fabric material. The slat includes a first contact surface. In use, the first contact surface contacts the second contact surface of an adjacent assembled vane.

In another embodiment, the architectural-structure covering comprises a headrail assembly and a plurality of vertically suspended side-by-side assembled vanes suspended from the headrail assembly, each assembled vane being coupled to the headrail assembly. Each assembled vane includes a fabric material, a first slat, and a second slat. The fabric material includes an inner surface, an outer surface, a top end, a bottom end, a first side portion, and a second side portion. The first slat includes a first surface, a second surface, a top end, a bottom end, a first side portion, and a second side portion. The first and second side portions of the first slat are coupled to the inner surface of the fabric material so that the fabric material extends across the outer surface of the first slat. The first slat and the fabric material overlap the first slat defining a first contact surface. The second slat includes a first surface, a second surface, a top end, a bottom end, a first side portion, and a second side portion. The first and second side portions of the second slat are coupled to the inner surface of the fabric material so that the fabric material extends across the outer surface of the second slat. The second slat and the fabric material overlap the second slat defining a second contact surface. In use, the first contact surface is configured to contact a second contact surface of an adjacent assembled vane.

While the present disclosure makes reference to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

The foregoing description has broad application. It should be appreciated that the concepts disclosed herein may apply to many types of coverings, in addition to the coverings described and depicted herein. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The phrases “at least one”, “one or more”, and “and/or”, as used herein, are open-ended expressions that are both conjunctive and disjunctive in operation. The terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. All rotational references describe relative movement between the various elements. Identification references (e.g., primary, secondary, first, second, third, fourth, etc.) are not intended to connote importance or priority, but are used to distinguish one feature from another. The drawings are for purposes of illustration only and the dimensions, positions, order and relative to sizes reflected in the drawings attached hereto may vary.

1. A vertically-suspended architectural-structure covering comprising:
a headrail assembly; and
a covering suspended from said headrail assembly, said covering comprising a plurality of vertically suspended side-by-side assembled vanes, each assembled vane being coupled to said headrail assembly;
wherein each assembled vane includes:
a fabric material including an inner surface, an outer surface, a top end, a bottom end, a first side portion, and a second side portion;
a slat including a first surface, a second surface, a top end, a bottom end, a first side portion and a second side portion, said slat being coupled to said fabric material; and
a first contact surface and a second contact surface;
wherein said first contact surface of a first assembled vane and a second contact surface of a second adjacent assembled vane have complementary, alternating curved surfaces so that when said first contact surface of said first assembled vane contacts said second contact surface of said second adjacent assembled vane, said first and second contact surfaces are nested with respect to each other; and
wherein the plurality of vertically suspended side-by side assembled vanes are arranged and configured to enable a user to pass through said covering.

2. The vertical architectural-structure covering of claim 1, wherein said slat is a first slat, and each assembled vane further comprises a second slat including a first surface, a second surface, a top end, a bottom end, a first side portion and a second side portion, said first side portion of said first slat being coupled to said first side portion of said fabric material; and said first side portion of said second slat being coupled to said second side portion of said fabric material.

3. The vertical architectural-structure covering of claim 2, wherein said first slat includes said first contact surface and said second slat includes said second contact surface so that when coupled to said headrail assembly, said first contact surface of said first slat of said first assembled vane is in contact with said second contact surface of said second slat of said second adjacent assembled vane.

4. The vertical architectural-structure covering of claim 3, wherein said first slat of said first assembled vane and second slat of said second assembled vane are coupled to one another along said bottom ends thereof.

5. The vertical architectural-structure covering of claim 3, wherein said first and second contact surfaces are substantially free of any fabric material so that there is substantially no fabric material between the first and second contact surfaces when said first slat and said second slat are nested with each other.

6. The vertical architectural-structure covering of claim 5, wherein said first side portion of said first slat is partially covered by said first side portion of said fabric material and said first side portion of said second slat is partially covered by said second side portion of said fabric material.

7. The vertical architectural-structure covering of claim 2, wherein said first slat of each assembled vane has a width, and said second slat of each assembled vane has a width, said width of said first slat being substantially equal to said width of said second slat; and said first slat of each assembled vane has a radius of curvature, and said second slat of each assembled vane has a radius of curvature, said radius of curvature of said first slat being substantially equal to said radius of curvature of said second slat.

8. The vertical architectural-structure covering of claim 2, wherein said first slat and said second slat each include first and second layers.

9. The vertical architectural-structure covering of claim 8, wherein said first layer is a non-woven layer and said second layer is a rigid material.

10. The vertical architectural-structure covering of claim 1, wherein said first side portion of said slat is coupled to said first side portion of said fabric material.

11. The vertical architectural-structure covering of claim 10, wherein said slat includes said first contact surface and said fabric material includes said second contact surface so that when coupled to said headrail assembly, said first contact surface of said slat of said first assembled vane contacts said second contact surface of said fabric material of said second assembled vane.

12. The vertical architectural-structure covering of claim 11, wherein for each assembled vane, said slat is coupled to said first side portion of said fabric material from substantially said top end thereof to said bottom end thereof.

13. The vertical architectural-structure covering of claim 1, wherein each assembled vane further comprises a second slat including a first surface, a second surface, a top end, a bottom end, a first side portion and a second side portion, said first and second side portions of said slat and said second slats being coupled to said inner surface of said fabric material.

14. The vertical architectural-structure covering of claim 13, wherein said fabric material includes said first and second contact surfaces so that when coupled to said headrail assembly, said first contact surface of said first assembled vane contacts said second contact surface of said second adjacent assembled vane.

15. The vertical architectural-structure covering of claim 14, wherein for each assembled vane, said slat and said second slat are coupled to said inner surface of said fabric material from substantially said top end thereof to said bottom end thereof.

16. A vertically-suspended architectural-structure covering comprising:
a headrail assembly; and
a covering suspended from said headrail assembly, said covering comprising a plurality of vertically suspended side-by-side assembled vanes, each assembled vane being coupled to said headrail assembly;
wherein each assembled vane includes:
a fabric material including an inner surface, an outer surface, a top end, a bottom end, a first side portion, and a second side portion;
a first slat including a first surface, a second surface, a top end, a bottom end, a first side portion and a second side portion, said first slat being coupled to said fabric material;
a second slat including a first surface, a second surface, a top end, a bottom end, a first side portion and a second side portion, said second slat being coupled to said fabric material;
wherein:
each of said assembled vanes includes a first contact surface for contacting a second contact surface of an adjacent assembled vane; and
for each assembled vane, said first and second contact surfaces have a complementary, alternating curved shape so that when said first contact surface of said first slat of a first assembled vane is in contact with said second contact surface of said second slat of a second assembled vane, said first slat and said second slat are nested with respect to each other.
